(19) United States
(12) Patent Application Publication
(10) Pub. No.: US 2024/0013572 A1
(43) Pub. Date: Jan. 11, 2024

(54) METHOD FOR FACE DETECTION, TERMINAL DEVICE AND NON-TRANSITORY COMPUTER-READABLE STORAGE MEDIUM

(71) Applicant: SHENZHEN PAX SMART NEW TECHNOLOGY CO., LTD., Shenzhen (CN)

(72) Inventors: Chenghe YANG, Shenzhen (CN); Jiansheng ZENG, Shenzhen (CN); Guiyuan LI, Shenzhen (CN); Yu WANG, Shenzhen (CN)

(21) Appl. No.: 18/370,177

(22) Filed: Sep. 19, 2023

Related U.S. Application Data
(63) Continuation-in-part of application No. PCT/CN2022/080800, filed on Mar. 15, 2022.

(30) Foreign Application Priority Data
Mar. 22, 2021 (CN) 202110302180.9

(51) Int. Cl. G06V 40/16; G06V 40/40; G06V 10/75

(52) U.S. Cl. CPC G06V 40/161; G06V 40/45; G06V 10/751

(57) ABSTRACT

The present application is applicable to the technical field of image processing, and provides a method and an apparatus for face detection, a terminal device, and a non-transitory computer-readable storage medium. The method includes: obtaining an image to be detected, where a first facial image is contained in the image to be detected; performing an initial detection on the image to be detected to obtain an initial detection result; comparing the first facial image in the image to be detected with a target facial image to obtain a comparison result, if the initial detection result indicates that the initial detection is passed; and determining a final face detection result of the image to be detected according to the comparison result. An accuracy of face detection can be effectively improved by performing the method for face detection.

### CROSS-REFERENCE TO RELATED APPLICATIONS

This application is a continuation-in-part of PCT patent application Serial No. PCT/CN2022/080800, filed on Mar. 15, 2022, which claims priority to Chinese patent application No. 202110302180.9, filed with CNIPA on Mar. 22, 2021, the entire contents each of which are incorporated herein by reference.

### FIELD

The present application relates to the field of image processing technologies, and more particularly, to a method for face detection, a terminal device and a non-transitory computer-readable storage medium.

### BACKGROUND

With the development of image processing technologies, face detection has gradually become the most potential biological identity verification method, and is widely used in the fields such as financial payment, safety monitoring and controlling, media entertainment, etc. In the existing face detection technology, a collected facial image needs to be compared with a facial image registered by a user to determine whether the collected facial image is the facial image of the user himself/herself.

However, in practical application, the collected facial image may have a “defect” itself. Thus, an accuracy of face detection is affected. For example, in the event that an image light is dark or a facial region in the image is occluded, as a consequence, key feature information in the image cannot be detected, and a detection result is affected accordingly.

### SUMMARY

Embodiments of the present application provide a method for face detection, a terminal device and a non-transitory computer-readable storage medium, which can improve the accuracy of face detection effectively.

In the first aspect, a method for face detection is provided in the embodiments of the present application. The method includes:
obtaining an image to be detected, where the image to be detected contains a first facial image;
performing an initial detection on the image to be detected to obtain an initial detection result;
comparing, if the initial detection result indicates that the initial detection is passed, the first facial image in the image to be detected with a target facial image to obtain a comparison result; and
determining a final face detection result of the image to be detected according to the comparison result.

In this embodiment of the present application, the initial detection is performed on the image to be detected. In this way, the image to be detected, which has a defect, may be excluded. If the initial detection performed on the image to be detected is passed, the first facial image contained in the image to be detected is compared with the target facial image, and the final face detection result is determined according to the comparison result. An accuracy of the face detection can be effectively improved through the method for face detection.

In one embodiment, said obtaining the image to be detected includes:
obtaining a RGB image and an infrared image, where both the RGB image and the infrared image contain the first facial image;
performing a liveness detection on the first facial image contained in the infrared image to obtain a liveness detection result; and
determining the RGB image as the image to be detected, if the liveness detection result indicates that the first facial image contained in the infrared image is a real face.

In one embodiment, said performing the liveness detection on the first facial image contained in the infrared image to obtain the liveness detection result includes:
detecting a plurality of facial contour key points in the infrared image;
cropping the first facial image contained in the infrared image according to the plurality of facial contour key points; and
inputting the first facial image contained in the infrared image into a trained liveness detection architecture, and outputting the liveness detection result through the trained liveness detection architecture.

In one embodiment, the initial detection includes at least one of detection items consisting of a face pose detection, a face occlusion detection, a face brightness detection and a face ambiguity detection;
said performing the initial detection on the image to be detected to obtain the initial detection result includes:
performing the detection items in the initial detection on the image to be detected to obtain detection results of the detection items; and
indicating that a face detection is passed by the initial detection result, if the detection results of the detection items in the initial detection indicate that all detections of the detection items are passed.

In one embodiment, the method further includes: performing the face pose detection on the image to be detected to obtain the detection result of the face pose detection when the initial detection is the face pose detection, said performing the face pose detection on the image to be detected to obtain the detection result of the face pose detection includes:
inputting the image to be detected into a trained face pose estimation model, and outputting face three-dimensional angle information through the trained face pose estimation model; and
determining a detection result of the face pose detection according to the face three-dimensional angle information and a preset angle range.

In one embodiment, the method further includes: performing the face occlusion detection on the image to be detected to obtain a detection result of the face occlusion detection when the initial detection is the face occlusion detection, said performing the face occlusion detection on the image to be detected to obtain a detection result of the face occlusion detection includes:
dividing the first facial image contained in the image to be detected into N facial regions, where N is a positive integer;
inputting the N facial regions into occlusion detection architectures respectively corresponding to the N facial regions, and outputting face occlusion detection results respectively corresponding to the N facial regions; and
determining a detection result of the face occlusion detection according to the face occlusion detection results respectively corresponding to the N facial regions.

In one embodiment, the method further includes: performing the face brightness detection on the image to be detected to obtain a detection result of the face brightness detection when the initial detection is the face brightness detection, said performing the face brightness detection on the image to be detected to obtain the detection result of the face brightness detection includes:
calculating a ratio of a number of target pixel points in the image to be detected to a number of all pixel points in the image to be detected, where pixel values of the target pixel points are within a preset gray value range; and
determining a detection result of the face brightness detection according to the ratio and a preset threshold value.

In one embodiment, the method further includes: performing the face ambiguity detection on the image to be detected to obtain a detection result of the face ambiguity detection when the initial detection is the face ambiguity detection, said performing the face ambiguity detection on the image to be detected to obtain the detection result of the face ambiguity detection includes:
calculating an ambiguity of the image to be detected; and
determining a detection result of the face ambiguity detection according to the ambiguity and a preset numerical range.

In the second aspect, a terminal device is provided in the embodiments of the present application. The terminal device includes a memory, a processor and a computer program stored in the memory and executable by the processor. Where, the processor is configured to, when executing the computer program, implement the method for face detection as described above.

In the third aspect, a non-transitory computer-readable storage medium is provided in the embodiments of the present application. The non-transitory computer-readable storage medium stores a computer program, that, when executed by the processor of the terminal device, causes the processor of the terminal device to implement the method for face detection as described above.

In the fourth aspect, a computer program product is provided in the embodiments of the present application. The computer program product stores a computer program, that, when executed by the processor of the terminal device, causes the processor of the terminal device to implement the method for face detection as described above.

It can be understood that, regarding the beneficial effects in the second aspect, the third aspect, and the fourth aspect, reference can be made to the relevant descriptions in the first aspect. The beneficial effects in the second aspect, the third aspect, and the fourth aspect are not repeatedly described herein.

### DESCRIPTION OF THE DRAWINGS

In order to describe the embodiments of the present application more clearly, a brief introduction regarding the accompanying drawings that need to be used for describing the embodiments of the present application or the existing technologies is given below. It is obvious that the accompanying drawings described below are merely some embodiments of the present application, a person of ordinary skill in the art can also acquire other drawings according to the current drawings without paying creative efforts.

FIG. 1 illustrates a schematic flow diagram of a method for face detection provided by one embodiment of the present application;

FIG. 2 illustrates a schematic diagram of a plurality of facial feature key points provided by one embodiment of the present application;

FIG. 3 illustrates a schematic diagram of a plurality of facial contour key points provided by one embodiment of the present application;

FIG. 4 illustrates a schematic diagram of removal process of background information provided by one embodiment of the present application;

FIGS. 5A-5B illustrate a schematic structural diagram of a first feature extractor provided by one embodiment of the present application;

FIG. 6 illustrates a schematic structural diagram of an liveness detection architecture provided by one embodiment of the present application;

FIG. 7 illustrates a schematic diagram of a F-Net model provided by one embodiment of the present application; and

FIG. 8 illustrates a schematic structural diagram of a terminal device provided by one embodiment of the present application.

### DETAILED DESCRIPTION OF EMBODIMENTS

In the following descriptions, in order to describe but not intended to limit the present application, concrete details including specific system structure and technique are proposed to facilitate a comprehensive understanding of the embodiments of the present application. However, a person of ordinarily skill in the art should understand that, the present application can also be implemented in some other embodiments from which these concrete details are excluded. In other conditions, detailed explanations of method, circuit, device and system well known to the public are omitted, so that unnecessary details which are disadvantageous to understanding of the description of the present application may be avoided.

It should be understood that, when a term “comprise/include” is used in the description and annexed claims, the term “comprise/include” indicates existence of the described characteristics, integer, steps, operations, elements and/or components, but not exclude existence or adding of one or more other characteristics, integer, steps, operations, elements, components and/or combination thereof.

In addition, in the descriptions of the present application, terms such as “first” and “second”, “third”, etc., are only used for distinguishing purpose in description, but shouldn't be interpreted as indication or implication of a relative importance.

The descriptions of “referring to one embodiment” and “referring to some embodiments”, and the like as described in the specification of the present application means that a specific feature, structure, or characters which are described with reference to this embodiment are included in one embodiment or some embodiments of the present application. Thus, the sentences of “in one embodiment”, “in some embodiments”, “in some other embodiments”, “in other embodiments”, and the like in this specification are not necessarily referring to the same embodiment, but instead indicate “one or more embodiments instead of all embodiments”, unless there is a special emphasis in other manner otherwise.

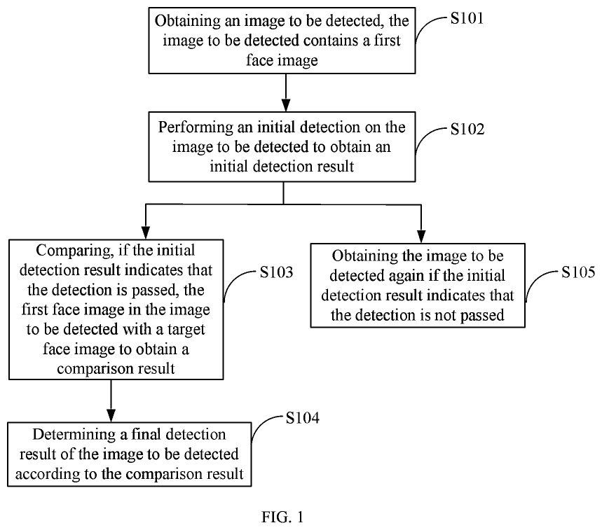

Referring to FIG. 1, FIG. 1 illustrates a schematic flow diagram of a method for face detection according to one embodiment of the present application. As an example rather than limitation, the method for face detection is implemented by a terminal device 9, and may include the following steps:

In a step of S101, an image to be detected is obtained, where the image to be detected contains a first facial image.

In one embodiment, RGB image of a target face is collected through a camera device, and the RGB image is recorded as the image to be detected. The image to be detected includes the first facial image and a background image corresponding to the target face.

In practical application, a condition of fake facial image, such as a printed facial image, a face mask, or a facial image in a screen of an electronic device, may exist. In order to avoid the occurrence of the condition of fake facial image, in another embodiment, face liveness detection needs to be performed.

One implementation method of the step S101 may include: obtaining the RGB image of the target face, and then performing a liveness detection on the first facial image contained in the RGB image to obtain a face liveness detection result; determining the RGB image as an image to be detected if the liveness detection result indicates that the first facial image contained in the RGB image is a real face.

However, when the RGB image is used for face liveness detection, the effect is bad. In order to improve the accuracy of the face liveness detection, another implementation method of the step S101 is provided in the embodiments of the present application. The implementation method includes: obtaining a RGB image and an infrared image, where both the RGB image and the infrared image contain the first facial image; performing the face liveness detection on the first facial image contained in the infrared image to obtain a face liveness detection result; and determining the RGB image as the image to be detected if the face liveness detection result indicates that the first facial image contained in the infrared image is a real face.

The RGB image and the infrared image may be obtained by photographing one same object to be photographed simultaneously by the same camera device, or be obtained by the same camera device by photographing the same object to be photographed successively. For example, the first camera device may generate the RGB image and the infrared image, the first camera device photographs the target face at the same time to obtain the RGB image and the infrared image of the target face. The first camera device may generate the RGB image of the target face by photographing first, and then generate the infrared image of the target face by photographing. In this condition, it needs to enable an interval time between two photographing operations to be short enough so as to ensure that the angle and the background of the target face with respect to the camera device do not change greatly.

The RGB image and the infrared image may also be obtained by photographing the same object to be photographed by different camera devices simultaneously, or be obtained by photographing the same object to be photographed by different camera devices successively. For example, the second camera device may generate the RGB image by photographing, the third camera device may generate the infrared image by photographing, the second camera device and the third camera device are instructed to photograph the target face at the same time, and the obtained RGB image and the infrared image include the first facial image corresponding to the target face. Furthermore, the target face may be photographed by the second camera device to obtain the RGB image. Then, the target face is photographed by the third camera device to obtain the infrared image. In this condition, the time interval between two photographing operations needs to be relatively short to ensure that the angle and the background of the target face with respect to the camera device do not change greatly.

In one embodiment, one implementation method of performing the face liveness detection on the first facial image contained in an infrared image includes: detecting a plurality of facial contour key points in the infrared image; cropping the first facial image contained in the infrared image according to the plurality of facial contour key points; and inputting the first facial image contained in the infrared image into a trained face liveness detection architecture, and outputting a face liveness detection result.

The infrared image includes the first facial image and a background image. In practical application, a liveness/non-liveness image may be contained in the background image of the collected infrared image. If the infrared image is input into the face liveness detection architecture (i.e., the feature information of the background image and the first facial image are comprehensively considered), the feature information corresponding to the background image in the infrared image will interfere with the feature information corresponding to the first facial image, thereby affecting the accuracy of the face liveness detection result. In order to solve the above problem, in this embodiment of the present application, background removal processing is first performed on the infrared image (i.e., detecting the facial contour key points in the infrared image; and cropping the first facial image contained in the infrared image according to the facial contour key points) to obtain the first facial image in the infrared image, and then performing the face liveness detection on the first facial image.

In one embodiment, one implementation method of detecting the plurality of facial contour key points in the infrared image may include: obtaining a plurality of facial feature key points on the first facial image in the infrared image; and determining the plurality of facial contour key points from the plurality of facial feature key points.

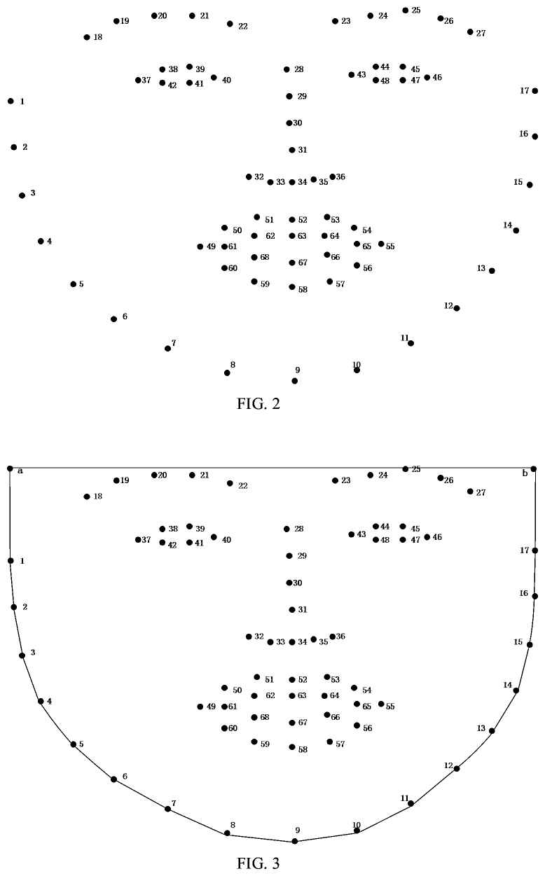

The infrared image may be input into the trained face detection architecture, and the plurality of facial feature key points are output. Preferably, a face detection architecture having 68 key points may be used. Referring to FIG. 2, FIG. 2 illustrates a schematic diagram of the facial feature key points according to one embodiment of the present application. The image to be processed is input into the trained face detection architecture, and position marks of the facial feature key points 1-68 shown in FIG. 2 are output through the trained face detection architecture.

Furthermore, one implementation method of determining the facial contour key points from the plurality of facial feature key points may include: determining a plurality of boundary points in the plurality of facial feature key points; and determining the facial contour key points according to the plurality of boundary points.

For example, as shown in FIG. 2, in the facial feature key points 1-68, facial feature key points 1-17 and facial feature key points 18-27 are boundary points.

The implementation methods of determining the plurality of facial contour key points according to the boundary points include:

For example, as shown in FIG. 2, in the facial feature key points 1-68, the facial features key points 1-17 and the facial feature key points 18-27 are boundary points.

There may exist some implementation methods for determining the facial contour key points according to the boundary points, which are listed below:

1. Boundary points are determined as facial contour key points.

For example, as shown in FIG. 2, boundary points 1-17 and 18-27 are determined as facial contour key points.

2. A boundary point with the maximum abscissa, a boundary point with the minimum abscissa, a boundary point with the maximum ordinate and a boundary point with the minimum ordinate are determined as the boundary point of the facial contour key points.

For example, as shown in FIG. 2, boundary points 1, 9, 16, and 25 are determined as facial contour key points.

3. An abscissa maximum value, an abscissa minimum value and an ordinate minimum value in the boundary points are calculated. A first vertex key point is determined according to the abscissa maximum value and the ordinate minimum value, and a second vertex key point is determined according to the abscissa minimum value and the ordinate minimum value. The boundary points 1-17, the first vertex key point and the second vertex key point are determined as the facial contour key points.

FIG. 3 illustrates a schematic diagram of the facial contour key points according to one embodiment of the present application. As shown in FIG. 3, the first vertex key point is represented by a (see the vertex at the upper left corner in FIG. 3), the second vertex key point (see the vertex at the upper right corner in FIG. 3) is b, and the contour of the facial image can be determined by the plurality of facial contour key points a, b and 1-17.

The contour of the facial image determined by the first method is smaller, and part of facial feature information is lost. The contour of the facial image determined by the second method is the minimum rectangle containing the facial image, and the contour includes more background images. The contour of the facial image determined by the third method is very appropriate, not only the integrity of the facial image is ensured, the background pattern is also removed completely.

In one embodiment, cropping the first facial image contained in the infrared image according to the facial contour key points may include: delineating a first region according to the facial contour key points on a preset layer filled with a first preset color; filling the first region in the preset layer with a second preset color to obtain a target layer; and performing an image overlay processing on the target layer and the image to be processed so as to obtain the facial image.

In this way, in the target layer, the first region delineated by the facial contour key points is filled with a second preset color, and the second region excluding the first region is filled with the first preset color. Exemplarily, a preset layer (e.g., a mask which may be stored in the form of program data) of black color (i.e., the second preset color) is first created; the facial contour key points are drawn as a curve through polylines function in OpenCV, and a region enclosed by the curve is determined as the first region; the first region is filled with a white color (i.e., the first preset color) through fillpoly function to obtain the target layer. A pixel-by-pixel bitwise and processing (i.e., image overlay processing) is performed on the target layer and the image to be processed to obtain the facial image.

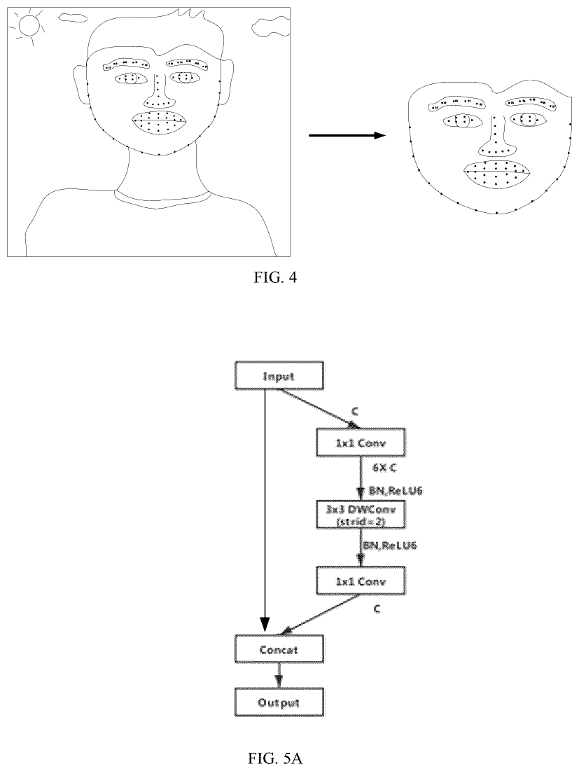

FIG. 4 illustrates a schematic diagram of a background removal processing according to one embodiment of the present application. The left image in FIG. 4 is the image to be processed before the background removal processing is performed, and the right image in FIG. 4 is the facial image after the background removal processing has been performed. As shown in FIG. 4, after performing the background removal processing, the background image can be removed while the complete facial image is retained.

After the first facial image is obtained from the infrared image, the first facial image is input into the trained face liveness detection architecture, and a face liveness detection result is output through the face liveness detection architecture.

In order to improve a feature extraction capability of the face liveness detection architecture, in the embodiments of the present application, the face liveness detection architecture includes a first feature extractor and an attention mechanism architecture. Both the first feature extractor and the attention mechanism architecture are used for extracting features. Where the attention mechanism architecture may enhance a learning ability of features (e.g., light reflection of a human eye, skin texture features, etc.) with discriminability. In one embodiment, the attention mechanism architecture may use a SENet architecture.

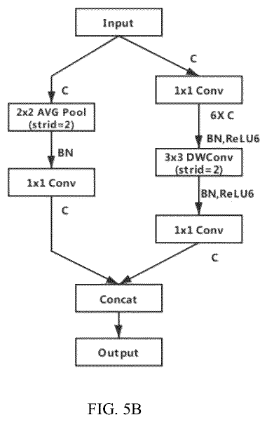

In addition, the present application differs from the prior art in that, in the first feature extractor of the embodiments of the present application, a parallel feature extraction network is incorporated. Specifically, referring to FIGS. 5A-5B, FIGS. 5A-5B illustrate a schematic structural diagram of a first feature extractor according to one embodiment of the present application. The first feature extractor structure in the prior art is shown in FIG. 5A, which includes an inverted residual network (including a second convolutional layer (1×1 CONV) for raising dimensions, a third convolutional layer (3×3 DW CONV), and a fourth convolutional layer (1×1 CONV) for dimensionality reduction. The structure of the first feature extractor in this embodiment of the present application is shown in FIG. 5B, which includes a first network and an inverted residual network connected in parallel. Where the first network includes a first average pooling layer (2×2 AVG Pool) and a first convolutional layer (1×1 Conv).

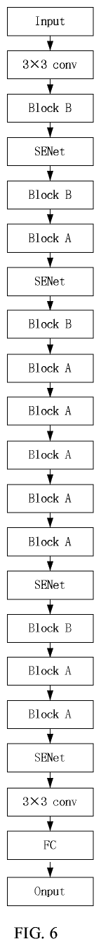

Exemplarily, referring to FIG. 6, FIG. 6 illustrates a schematic structural diagram of a face liveness detection architecture according to one embodiment of the present application. Block A module in FIG. 6 is the first feature extractor shown in 5A, and Block B module in FIG. 6 is the first feature extractor shown in FIG. 5B. In the face liveness detection architecture shown in FIG. 6, the first feature extractor and the attention mechanism architecture perform feature extraction tasks alternatively. Finally, the extracted feature vectors are fully connected to an output layer through FC. In a face liveness detection process, the output feature vectors are converted into probability values through a classification layer (e.g., softmax), and whether the feature vectors are a liveness can be determined through the probability values. The liveness detection architecture shown in FIG. 6 is provided with strong defense capability and security for two dimensional (2D) and three dimensional (3D) facial images, and the accuracy of liveness detection is relatively high.

The aforesaid embodiments are equivalent to first performing the liveness detection process first, and determining the collected RGB image as the image to be detected after determining that the collected facial image is the real face, and performing subsequent steps. By performing the aforesaid method, the condition of fake face may be effectively avoided, and the accuracy of face detection may be improved.

In a step of S102, an initial detection is performed on the image to be detected to obtain an initial detection result.

In practical application, the collected image to be detected may have a “defect” itself, and the accuracy of face detection is affected accordingly. For example, when image light is dark, or the facial region in the image is occluded, such that the key feature information in the image cannot be detected, and the detection result is affected.

In order to improve the face detection result, in this embodiment of the present application, the image to be detected is initially detected, which is for the purpose of excluding the image to be detected with the “defect”. The initial detection may include at least one of the following detection items: a face pose detection, a face occlusion detection, a face brightness detection, and a face ambiguity detection. Each of the detection items is described below.

One, performing the face pose detection on the image to be detected to obtain a detection result of the face pose detection may include the following steps: inputting the image to be detected into a trained face posture estimation model, and outputting face three-dimensional angle information; and determining the detection result of the face pose detection according to the face three-dimensional angle information and a preset angle range.

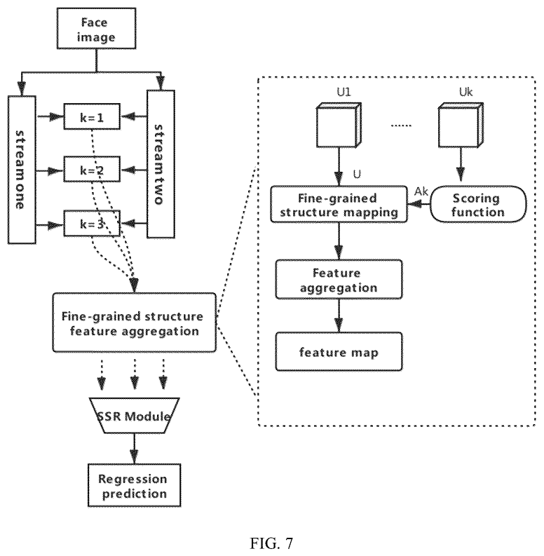

In one embodiment, the face pose estimation model may adopt an FSA-Net model. This model is composed of two branches of Stream one and Steam two. The algorithm is used to extract three features on layers with different depths (there are multiple layers firstly, however, only three layers are extracted). Then, fine-grained structure features are fused, and then, the face three-dimensional angle information (Roll, Pitch and Yaw) is obtained by performing regression prediction through SSR module (the sum of squares due to regression). Referring to FIG. 7, FIG. 7 illustrates a schematic diagram of the FSA-Net model according to one embodiment of the present application. This model has a faster data processing speed, which facilitates improving the efficiency of face detection.

In one embodiment, if the face three-dimensional angle information is within the preset angle range, the detection result of the face pose detection indicates that the face pose detection is passed. If the face three-dimensional angle information is not within the preset angle range, the detection result of the face pose detection indicates that the face pose detection is not passed.

Two, performing the face occlusion detection on the image to be detected to obtain a detection result of the face occlusion detection may include the following steps: dividing the first facial image contained in the image to be detected into N facial regions, where N is a positive integer; inputting the N facial regions into occlusion detection architectures respectively corresponding to the N facial regions, and outputting occlusion detection results corresponding to the N facial regions; and determining the detection result of the face occlusion detection according to the occlusion detection results corresponding to the N facial regions.

Exemplarily, the first facial image may be divided into 7 regions, such as the left eye, the right eye, the nose, the mouth, the chin, the left face, and the right face, according to the detected 68 key points on the first facial image. Then, the 7 regions are input into occlusion detection architectures respectively corresponding to the 7 regions. For example, a left-eye image is input into a left-eye occlusion detection architecture, a nose image is input into a nose occlusion detection architecture. The 7 occlusion detection architectures output occlusion probability values respectively, and then determine whether the occlusion probability values are within a preset probability range; if the occlusion probability values are within the preset probability range, it indicates that the current facial region is not occluded; if the occlusion probability values are not within the preset probability range, it indicates that the current facial region is occluded. It should be noted that the foregoing is merely one example of dividing of facial regions, and does not specifically define a division rule, the number of facial regions.

In one embodiment, after the face occlusion detection results corresponding to the N facial regions are obtained, the detection result of the facial occlusion detection may be determined according to the preset rule and the N occlusion detection results.

Exemplarily, the preset rule may be defined as: each of N occlusion detection results indicates that the face is not occluded; correspondingly, if each of the N occlusion detection results indicates that the face is not occluded, the detection result of the face occlusion detection indicates that the face occlusion detection is passed; if there exists at least one occlusion detection result indicating that the face is occluded in the N occlusion detection results, the detection result of the face occlusion detection indicates that the face occlusion detection is not passed successfully.

The preset rule can also be defined as: an occlusion ratio is greater than a preset ratio. Where the occlusion ratio is a ratio of the number of occlusion detection results indicating that the face is not occluded to the number of the occlusion detection results indicating that the face is occluded. If the occlusion ratio in the N occlusion detection results is greater than the preset ratio, the detection result of the face occlusion detection indicates that the detection is passed successfully. If the occlusion ratio in the N occlusion detection results is less than or equal to the preset ratio, the detection result of the face occlusion detection indicates that the detection is not passed.

It should be noted that the foregoing is merely one example of the preset rule. In actual application, the preset rule may be formulated according to actual requirement.

Three, performing the face brightness detection on the image to be detected to obtain a detection result of the face brightness detection may include the following steps: calculating a ratio of the number of target pixel points in the image to be detected to the number of all pixel points in the image to be detected; where the pixel values of the target pixel points are within a preset gray value range; and determining the detection result of the face brightness detection according to the ratio and a preset threshold value.

A grayscale histogram of the image to be detected may be pre-calculated. Then, the preset grayscale range is set according to the grayscale histogram.

Exemplarily, a pixel point with a pixel value within the range of (0, 30) is considered as an underexposed point, and the underexposed point is determined as one target pixel point. Then, the ratio of the number of the target pixel points to the number of all pixel points in the image to be detected is calculated. If the ratio is greater than the preset threshold value. A pixel point having a pixel value within the range of (220, 255) may also be considered as an over-exposed point, and the over-exposed point can also be determined as one target pixel point. Then, a ratio of the number of target pixel points to the number of all pixel points in the image to be detected is calculated; if the ratio of the number of target pixel points to the number of all pixel points in the image to be detected is greater than the preset threshold value, it indicates that the face brightness detection is not passed.

Four, performing the face ambiguity detection on the image to be detected to obtain a detection result of the face ambiguity detection may include following steps: calculating the ambiguity of the image to be detected; and determining the detection result of the face ambiguity detection according to the ambiguity and a preset numerical range.

In one embodiment, one implementation method of calculating the ambiguity of the image to be detected is: calculating ambiguity values of all pixel points in the image to be detected by using a Laplacian function; and then calculating a variance of ambiguity values to obtain the ambiguity.

In one embodiment, one implementation method of calculating the ambiguity of the image to be detected is: calculating grayscale differences of all pixel points in the image to be detected; then, calculating the sum of squares of the grayscale differences, and determining the sum of squares as the ambiguity of the image to be detected.

Certainly, other methods may also be used to calculate the ambiguity of the image to be detected, which are not specifically limited herein.

In one embodiment, after the ambiguity of the image to be detected is obtained through calculation, if the ambiguity is within the preset numerical range, the detection result of the face ambiguity detection is that the face ambiguity detection is passed. If the ambiguity is not within the preset numerical range, the detection result of the face ambiguity detection is that the face ambiguity detection is not passed.

The aforesaid detection items may be processed in series, and may also be processed in parallel. For example, when serial processing is performed on the detection items, if the detection result of the first detection item is that the detection is passed, the second detection item is executed; if the detection result of the second detection item is that the detection is passed, the third detection item is executed; and so on. If the detection result of any detection item is that the detection on the image to be detected is not passed, it indicates that the initial detection result is not passed.

When parallel processing is performed on the detection items, the detection items may be executed simultaneously or successively. In one embodiment, if the detection result of any M detection items is that the detection on the image to be detected is not passed, it indicates that the initial detection result is not passed, where, M is a positive integer. As an alternative, if the detection result of one specified detection item is that the detection on the image to be detected is not passed, it indicates that the initial detection result is not passed.

In a step of S103, the first facial image in the image to be detected is compared with the target facial image to obtain a comparison result, if the initial detection result indicates that the initial detection is passed.

In one embodiment, the comparison result may be determined by calculating the Euclidean distance which is formulized as:

$$d ( x , y ) = \sqrt{{\sum }_{i = 1}^{H} {( {x}_{i} - {y}_{i} )}^{2}}$$

Where, xi represents a feature value of a pixel point in the first facial image, and yi represents a feature value of a pixel point in the target facial image.

Certainly, other distance calculation methods (e.g., Mahalanobis distance, etc.) may also be used to determine the comparison result, which is not specifically limited herein.

In one embodiment, the method for calculating the feature value may use an Insight face algorithm, and the specific steps of the algorithm are as follows:

Mobilefacenet is used as a main architecture of a neural network to extract a facial feature of an image to be detected, so as to obtain a facial feature vector.

L2 regularization is performed on the facial feature vector xi to obtain

$$\frac{{x}_{i}}{‖ {x}_{i} ‖} ,$$

and L2 regularization is performed on each column wj in a matrix W (including L target facial images processed in batches) of a feature matrix to obtain

$$\frac{{w}_{j}}{‖ {w}_{j} ‖} ;$$

the first two items of

$$\frac{{x}_{i}}{‖ {x}_{i} ‖} \times \frac{{w}_{j}}{‖ {w}_{j} ‖} \times cos ( {θ}_{{y}_{j}} )$$

are assigned to be 1 so as to obtain a full connection output cos(θⱼ), j∈[1, . . . , H];
an inverse cosine operation is on the corresponding real label value cos (θ_{y}_{ⱼ}) in the output to obtain θ_{y}_{ⱼ};
since the Sphereface, ArcFace and Cosface in the mobilefacenet model have m parameters, which are respectively represented as m1, m2, and m3 herein. Thus, the three algorithms are integrated together to obtain an integrated value cos (m1θ_{y}_{ⱼ}+m2)m3;

the obtained integration value is amplified by multiplying with a scale parameter to obtain an output s×cos (θ_{y}_{ⱼ}); then, the output s×cos(θ_{y}_{ⱼ}) is input into a softmax function to obtain a finally output probability value, and the probability value is used as the feature value.

In a step of S104, a final detection result of the image to be detected is determined according to the comparison result.

In one embodiment, when the comparison result is a distance value between the first facial image and the target facial image, if the comparison result is within the preset distance range, the final detection result indicates that the first facial image matches with the target facial image. If the comparison result is not within the preset distance range, the final detection result indicates that the first facial image does not match with the target facial image.

In a step of S105, the image to be detected is obtained again if the initial detection result indicates that the initial detection is not passed.

In this embodiment of the present application, firstly, the image to be detected is initially detected, such that an image to be detected with “defect” can be excluded. If the image to be detected passes the initial detection, the first facial image in the image to be detected is compared with the target facial image, and the final detection result is determined according to the comparison result. By performing the face detection method, the accuracy of face detection can be effectively improved.

It should be understood that, the values of serial numbers of the steps in the aforesaid embodiments do not indicate an order of execution sequences of the steps; instead, the execution sequences of the steps should be determined by functionalities and internal logic of the steps, and thus shouldn't be regarded as limitation to implementation processes of the embodiments of the present application.

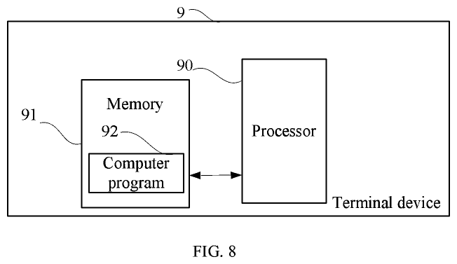

FIG. 8 illustrates a schematic diagram of a terminal device 9 provided by one embodiment of the present application. As shown in FIG. 8, the terminal device 9 in this embodiment includes: at least one processor 90 (only one processor is shown in FIG. 8), a memory 91, and a computer program 92 stored in the memory 91 and executable by the processor 90. The processor 90 is configured to, when executing the computer program 92, perform steps of the method for face detection, including:
obtaining an image to be detected from a camera device, wherein the image to be detected contains a first facial image;
performing an initial detection on the image to be detected to obtain an initial detection result;
comparing, if the initial detection result indicates that the initial detection is passed, the first facial image in the image to be detected with a target facial image to obtain a comparison result; and
determining a final face detection result of the image to be detected according to the comparison result.

In one embodiment, the processor is further configured to perform the step of obtaining the image to be detected from the camera device by:
obtaining a RGB image and an infrared image from the camera device, wherein both the RGB image and the infrared image contain the first facial image;
performing a face liveness detection on the first facial image contained in the infrared image to obtain a face liveness detection result; and
determining the RGB image as the image to be detected, if the face liveness detection result indicates that the first facial image contained in the infrared image is a real face.

In one embodiment, the processor is further configured to perform the step of performing the liveness detection on the first facial image contained in the infrared image to obtain the liveness detection result by:
detecting a plurality of facial contour key points in the infrared image;
cropping the first facial image contained in the infrared image according to the plurality of facial contour key points; and
inputting the first facial image contained in the infrared image into a trained liveness detection architecture, and outputting the liveness detection result through the trained liveness detection architecture.

In one embodiment, the initial detection includes at least one of detection items consisting of a face pose detection, a face occlusion detection, a face brightness detection and a face ambiguity detection;
the processor is further configured to perform the step of performing the initial detection on the image to be detected to obtain the initial detection result by:
performing the detection items in the initial detection on the image to be detected to obtain detection results of the detection items; and
indicating that a face detection is passed by the initial detection result, if the detection results of the detection items in the initial detection indicate that all detections of the detection items are passed.

In one embodiment, the processor is further configured to, when the initial detection is the face pose detection, perform the face pose detection on the image to be detected to obtain the detection result of the face pose detection.

More specifically, the processor is configured to perform the face pose detection on the image to be detected to obtain the detection result of the face pose detection by:
inputting the image to be detected into a trained face pose estimation model, outputting face three-dimensional angle information through the trained face pose estimation model; and
determining the detection result of the face pose detection according to the face three-dimensional angle information and a preset angle range.

In one embodiment, the processor is further configured to, when the initial detection is the face occlusion detection, perform the face occlusion detection on the image to be detected to obtain a detection result of the face occlusion detection.

More specifically, the processor is configured to perform the face occlusion detection on the image to be detected to obtain the detection result of the face occlusion detection by:
dividing the first facial image contained in the image to be detected into N facial regions, wherein N is a positive integer;
inputting the N facial regions into occlusion detection architectures respectively corresponding to the N facial regions, and outputting face occlusion detection results respectively corresponding to the N facial regions; and
determining the detection result of the face occlusion detection according to the face occlusion detection results respectively corresponding to the N facial regions.

In one embodiment, the processor is further configured to, when the initial detection is the face brightness detection, perform the face brightness detection on the image to be detected to obtain a detection result of the face brightness detection.

More specifically, the processor is configured to perform the face brightness detection on the image to be detected to obtain the detection result of the face brightness detection by:
calculating a ratio of a number of target pixel points in the image to be detected to a number of all pixel points in the image to be detected, wherein pixel values of the target pixel points are within a preset gray value range; and
determining the detection result of the face brightness detection according to the ratio and a preset threshold value.

In one embodiment, the processor is further configured to, when the initial detection is the face ambiguity detection, perform the face ambiguity detection on the image to be detected to obtain a detection result of the face ambiguity detection.

More specifically, the processor is configured to perform the face ambiguity detection on the image to be detected to obtain the detection result of the face ambiguity detection by:
calculating an ambiguity of the image to be detected; and
determining the detection result of the face ambiguity detection according to the ambiguity and a preset numerical range.

The terminal device 9 can be a computing device such as a desktop computer, a laptop computer, a palm computer, a cloud server, etc. The terminal device 9 may include, but is not limited to: the processor, the memory. A person of ordinary skill in the art can understand that, FIG. 8 is only one example of the terminal device 9, but should not be constituted as limitation to the terminal device 9, more or less components than the components shown in FIG. 8 may be included. Some components or different components may be combined. For example, the terminal device 9 may also include an input and output device, a network access device, etc.

The so-called processor 90 may be central processing unit (CPU), and may also be other general purpose processor, digital signal processor (DSP), application specific integrated circuit (ASIC), field-programmable gate array (FGPA), or some other programmable logic devices, discrete gate or transistor logic device, discrete hardware component, etc. The general purpose processor may be a microprocessor, as an alternative, the processor may also be any conventional processor, or the like.

In some embodiments, the memory 91 may be an internal storage unit of the terminal device 9, such as a hard disk or a memory of the terminal device 9. In some other embodiments, the memory 91 may also be an external storage device of the terminal device 9, such as a plug-in hard disk, a SMC (Smart Media Card), a SD (Secure Digital) card, a FC (Flash Card) equipped on the terminal device 9. Furthermore, the memory 91 may not only include the internal storage unit of the terminal device 9, but also include the external memory of the terminal device 9. The memory 91 is configured to store operating systems, applications, Boot Loader, data and other procedures, such as program codes of the compute program, etc. The memory 91 may also be configured to store data that has been output or being ready to be output temporarily.

Anon-transitory computer-readable storage medium is further provided in one embodiment of the present application. The non-transitory computer-readable storage medium store a computer program, that, when executed by the processor 90 of the terminal device 9, causes the processor 90 of the terminal device 9 to perform the steps of the various method embodiments.

A computer program product is further provided in one embodiment of the present application. The computer program product is configured to, when executed on the terminal device 9, causes the terminal device 9 to perform the steps of the various method embodiments.

In the aforesaid embodiments, the descriptions of the various embodiments are emphasized respectively. Regarding the part of one embodiment which has not been described or disclosed in detail, reference can be made to relevant descriptions in other embodiments.

The aforesaid embodiments are merely used to explain the technical solutions of the present application, rather than limiting the technical solutions of the present application. Although the present application has been described in detail with reference to the embodiments described above, a person of ordinary skill in the art should understand that the technical solutions described in these embodiments may still be modified, or some or all technical features in the embodiments may be equivalently replaced. However, these modifications or replacements do not make the essences of corresponding technical solutions to deviate from the spirit and the scope of the technical solutions of the embodiments of the present application, and should all be included in the protection scope of the present application.

1. A method for face detection implemented by a terminal device, comprising:
obtaining, by the terminal device, an image to be detected from a camera device, wherein the image to be detected contains a first facial image;
performing, by the terminal device, an initial detection on the image to be detected to obtain an initial detection result;
comparing, by the terminal device, if the initial detection result indicates that the initial detection is passed, the first facial image in the image to be detected with a target facial image to obtain a comparison result; and
determining, by the terminal device, a final face detection result of the image to be detected according to the comparison result.

2. The method for face detection according to claim 1, wherein said obtaining, by the terminal device, the image to be detected from the camera device comprises:
obtaining a RGB image and an infrared image from the camera device, wherein both the RGB image and the infrared image contain the first facial image;
performing, by the terminal device, a face liveness detection on the first facial image contained in the infrared image to obtain a face liveness detection result; and
determining the RGB image as the image to be detected, if the face liveness detection result indicates that the first facial image contained in the infrared image is a real face.

3. The method for face detection according to claim 2, wherein said performing, by the terminal device, the liveness detection on the first facial image contained in the infrared image to obtain the liveness detection result comprises:
detecting, by the terminal device, a plurality of facial contour key points in the infrared image;
cropping, by the terminal device, the first facial image contained in the infrared image according to the plurality of facial contour key points; and
inputting, by the terminal device, the first facial image contained in the infrared image into a trained liveness detection architecture, and outputting the liveness detection result through the trained liveness detection architecture.

4. The method for face detection according to claim 1, wherein the initial detection comprises at least one of detection items consisting of a face pose detection, a face occlusion detection, a face brightness detection and a face ambiguity detection;
said performing, by the terminal device, the initial detection on the image to be detected to obtain the initial detection result comprises:
performing, by the terminal device, the detection items in the initial detection on the image to be detected to obtain detection results of the detection items; and
indicating that a face detection is passed by the initial detection result, if the detection results of the detection items in the initial detection indicate that all detections of the detection items are passed.

5. The method for face detection according to claim 4, further comprising: performing, by the terminal device, the face pose detection on the image to be detected to obtain a detection result of the face pose detection when the initial detection is the face pose detection;
said performing, by the terminal device, the face pose detection on the image to be detected to obtain the detection result of the face pose detection comprises:
inputting the image to be detected into a trained face pose estimation model, and outputting face three-dimensional angle information through the trained face pose estimation model; and
determining the detection result of the face pose detection according to the face three-dimensional angle information and a preset angle range.

6. The method for face detection according to claim 4, further comprising: performing, by the terminal device, the face occlusion detection on the image to be detected to obtain a detection result of the face occlusion detection when the initial detection is the face occlusion detection;
said performing, by the terminal device, the face occlusion detection on the image to be detected to obtain the detection result of the face occlusion detection comprises:
dividing the first facial image contained in the image to be detected into N facial regions, wherein N is a positive integer;
inputting the N facial regions into occlusion detection architectures respectively corresponding to the N facial regions, and outputting face occlusion detection results respectively corresponding to the N facial regions; and
determining the detection result of the face occlusion detection according to the face occlusion detection results respectively corresponding to the N facial regions.

7. The method for face detection according to claim 4, further comprising: performing, by the terminal device, the face brightness detection on the image to be detected to obtain a detection result of the face brightness detection when the initial detection is the face brightness detection;
said performing, by the terminal device, the face brightness detection on the image to be detected to obtain the detection result of the face brightness detection comprises:
calculating a ratio of a number of target pixel points in the image to be detected to a number of all pixel points in the image to be detected, wherein pixel values of the target pixel points are within a preset gray value range; and
determining the detection result of the face brightness detection according to the ratio and a preset threshold value.

8. The method for face detection according to claim 4, further comprising: performing, by the terminal device, the face ambiguity detection on the image to be detected to obtain a detection result of the face ambiguity detection when the initial detection is the face ambiguity detection;
said performing, by the terminal device, the face ambiguity detection on the image to be detected to obtain the detection result of the face ambiguity detection comprises:
calculating an ambiguity of the image to be detected; and
determining the detection result of the face ambiguity detection according to the ambiguity and a preset numerical range.

9. A terminal device, comprising a memory, a processor and a computer program stored in the memory and executed by the processor, wherein the processor is configured to, when executing the computer program, perform steps of a method for face detection, comprising:
obtaining an image to be detected from a camera device, wherein the image to be detected contains a first facial image;
performing an initial detection on the image to be detected to obtain an initial detection result;
comparing, if the initial detection result indicates that the initial detection is passed, the first facial image in the image to be detected with a target facial image to obtain a comparison result; and
determining a final face detection result of the image to be detected according to the comparison result.

10. A non-transitory computer readable storage medium, which stores a computer program, that, when executed by a processor of a terminal device, causes the processor of the terminal device to implement steps of the method for face detection according to claim 1.

11. The terminal device according to claim 9, wherein the processor is further configured to perform the step of obtaining the image to be detected from the camera device by:
obtaining a RGB image and an infrared image from the camera device, wherein both the RGB image and the infrared image contain the first facial image;
performing a face liveness detection on the first facial image contained in the infrared image to obtain a face liveness detection result; and
determining the RGB image as the image to be detected, if the face liveness detection result indicates that the first facial image contained in the infrared image is a real face.

12. The terminal device according to claim 11, wherein the processor is further configured to perform the step of performing the liveness detection on the first facial image contained in the infrared image to obtain the liveness detection result by:
detecting a plurality of facial contour key points in the infrared image;
cropping the first facial image contained in the infrared image according to the plurality of facial contour key points; and
inputting the first facial image contained in the infrared image into a trained liveness detection architecture, and outputting the liveness detection result through the trained liveness detection architecture.

13. The terminal device according to claim 9, wherein the initial detection comprises at least one of detection items consisting of a face pose detection, a face occlusion detection, a face brightness detection and a face ambiguity detection;
the processor is further configured to perform the step of performing the initial detection on the image to be detected to obtain the initial detection result by:
performing the detection items in the initial detection on the image to be detected to obtain detection results of the detection items; and
indicating that a face detection is passed by the initial detection result, if the detection results of the detection items in the initial detection indicate that all detections of the detection items are passed.

14. The terminal device according to claim 13, wherein the processor is further configured to, when the initial detection is the face pose detection, perform the face pose detection on the image to be detected to obtain a detection result of the face pose detection;
wherein the processor is configured to perform the face pose detection on the image to be detected to obtain the detection result of the face pose detection by:
inputting the image to be detected into a trained face pose estimation model, outputting face three-dimensional angle information through the trained face pose estimation model; and
determining a detection result of the face pose detection according to the face three-dimensional angle information and a preset angle range.

15. The terminal device according to claim 13, wherein the processor is further configured to, when the initial detection is the face occlusion detection, perform the face occlusion detection on the image to be detected to obtain a detection result of the face occlusion detection;
wherein the processor is configured to perform the face occlusion detection on the image to be detected to obtain the detection result of the face occlusion detection by:
dividing the first facial image contained in the image to be detected into N facial regions, wherein N is a positive integer;
inputting the N facial regions into occlusion detection architectures respectively corresponding to the N facial regions, and outputting face occlusion detection results respectively corresponding to the N facial regions; and
determining the detection result of the face occlusion detection according to the face occlusion detection results respectively corresponding to the N facial regions.

16. The terminal device according to claim 13, wherein the processor is further configured to, when the initial detection is the face brightness detection, perform the face brightness detection on the image to be detected to obtain a detection result of the face brightness detection;
wherein the processor is configured to perform the face brightness detection on the image to be detected to obtain the detection result of the face brightness detection by:
calculating a ratio of a number of target pixel points in the image to be detected to a number of all pixel points in the image to be detected, wherein pixel values of the target pixel points are within a preset gray value range; and
determining the detection result of the face brightness detection according to the ratio and a preset threshold value.

17. The terminal device according to claim 13, wherein the processor is further configured to, when the initial detection is the face ambiguity detection, perform the face ambiguity detection on the image to be detected to obtain a detection result of the face ambiguity detection;
wherein the processor is configured to perform the face ambiguity detection on the image to be detected to obtain the detection result of the face ambiguity detection by:
calculating an ambiguity of the image to be detected; and
determining the detection result of the face ambiguity detection according to the ambiguity and a preset numerical range.

18. The method for face detection according to claim 2, wherein the initial detection comprises at least one of detection items consisting of a face pose detection, a face occlusion detection, a face brightness detection and a face ambiguity detection;
said performing, by the terminal device, the initial detection on the image to be detected to obtain the initial detection result comprises:
performing, by the terminal device, the detection items in the initial detection on the image to be detected to obtain detection results of the detection items; and
indicating that a face detection is passed by the initial detection result, if the detection results of the detection items in the initial detection indicate that all detections of the detection items are passed.

19. The method for face detection according to claim 3, wherein the initial detection comprises at least one of detection items consisting of a face pose detection, a face occlusion detection, a face brightness detection and a face ambiguity detection;
said performing, by the terminal device, the initial detection on the image to be detected to obtain the initial detection result comprises:
performing, by the terminal device, the detection items in the initial detection on the image to be detected to obtain detection results of the detection items; and
indicating that a face detection is passed by the initial detection result, if the detection results of the detection items in the initial detection indicate that all detections of the detection items are passed.
